(19) United States
(12) Patent Application Publication
(10) Pub. No.: US 2003/0162546 A1
(43) Pub. Date: Aug. 28, 2003

(54) Digital and method for digital data transmission

(76) Inventor: Mark Jordan, Warwickshire (GB)

Correspondence Address: OSTROLENK FABER GERB & SOFFEN, 1180 AVENUE OF THE AMERICAS, NEW YORK, NY, 100368403

(21) Appl. No.: 10/240,370

(22) PCT Filed: Mar. 29, 2001
(86) PCT No.: PCT/GB01/01403

(30) Foreign Application Priority Data
Mar. 29, 2000 (GB) 0007646.3

(51) Int. Cl. H04Q 7/20

(52) U.S. Cl. 455/446; 455/422; 455/447

(57) ABSTRACT

The present invention provides a broadcasting system comprising a plurality of geographically separate transmitting stations. The system comprises a first transmitting station (12) having means for broadcasting on a first channel over a first area of coverage (10), and a second transmitting station having means for broadcasting over a second area of coverage (14, 16) which overlaps with the first area of coverage. The system further comprises means (40, 42, 44, or 46) for transmitting data on the first channel over a portion of the second area of coverage (48, 50, 52 or 54) that is distinct from the overlap between the first and second broadcast areas.

As use of digital data services grows, the time taken to move the data from one place to another becomes more critical. Unless dedicated high speed data lines are used (which usually carries a high cost) delays caused by the download time of information can be extremely frustrating.

Perhaps the best example of this is the World Wide Web (WWW). As interest in e-commerce and other computer-enabled services grows, the competition between providers will continue to grow. One way of differentiating services from those of another company is to provide more facilities, better graphics, more information and so on. Consequently Web pages have tended to grow in size which, in turn, means long download times via the traditional route using a modem and a dial-up-connection via the Internet at approximately 33 kBits/second. The problem is so widespread that the World Wide Web has been dubbed the “World Wide Wait”.

One partial solution to this is the Integrated Services Digital Network (ISDN) which allows a consumer to lease higher-capacity lines. If a single ISDN line is installed, the data transfer rate is approximately doubled to 64 kBits/second. This can be increased by renting a higher capacity circuit, e.g. in the UK, British Telecom (BT) Megastream of up to 2 Mps, but this is even more expensive. Even with faster connections, limitations placed on the speed of download by the Internet Service Provider (ISP) can cause delays.

The problems are exacerbated by the symmetrical nature of the existing data paths. Mostly the transfer of data that is required is from the central resource to individual users with little, or very little data flowing in the opposite direction. For example, in the case of the World Wide Web, the information flowing from a user to the server is often no more than Universal Resource Locators (URLs), identification of products, services or information sought and so on. The nature of the data transfer is highly asymmetrical (approximately in a ratio of 1000:1) and yet the existing channels in widespread use are usually symmetrical. This wastes nearly 50% of the available bandwidth.

A company called Spacetec Limited offers a system called Eurosky—see http://www.spacetec.co.uk/Eurosky/system.html. This provides data from the internet at speeds of 3 to 4 times that of an ISDN via a satellite and receiver dish arrangement. Although this system addresses the problem of asymmetry, it is a rather complex, and hence costly, system.

The present invention has the object of ameliorating the above disadvantages.

According to a first aspect of the present invention there is provided a broadcasting system comprising a plurality of geographically separate transmitting stations, the system comprising:

a first transmitting station comprising means for broadcasting on a first channel over a first area of coverage;

a second transmitting station comprising means for broadcasting over a second area of coverage which overlaps with the first area of coverage;

further comprising means for transmitting data on the first channel over a portion of the second area of coverage that is distinct from the overlap between the first and second broadcast areas.

The invention generally provides a technique for using electromagnetic spectrum bandwidth that is otherwise unusable or “sterilised”. Where a number of different transmitters are provided to cover a particular area (e.g. a country) there will be a region between adjacent transmitters where signals can be received from both transmitters. Clearly the same frequencies cannot be used in adjoining areas because the signals will interfere, even if they are carrying the same signal. However, the present inventors have realised that this leaves a large amount of geographically-limited bandwidth that can be exploited to provide other services by careful selection of the direction, channel, beam width, forward error correction rate and power of transmitted signals. The invention is applicable to the transmission of digital signals since these are “cleaner” than analogue signals.

In one embodiment, use of the present invention will increase the speed of Web page download to a rate of up to 31 Mbps.

In a preferred embodiment the transmitters are co-located with existing broadcasting stations. This has the advantage that positions from which there is good propagation (e.g. hills or tall buildings), readily available power supplies and issues of electromagnetic interference have usually already been addressed. This feature becomes more significant in the case of broadcasting stations for services that are generally received using directional receive antennas. A good example is television transmission which, in the UK, occurs between channel 21 and channel 68 (471-854 MHz) in the Ultra High Frequency (UHF) waveband. The vast majority of the viewing population receive these transmissions using a directional Yagi antenna mounted high on their building. By co-locating the transmitter in accordance with the invention with the existing TV transmission antennas, the reception of the additional signals will be improved. Clearly this feature is not vital for transmissions which can readily be received by unidirectional antennas or where an additional, dedicated antenna can be used for the data service.

In a further preferred embodiment, a directional transmitting antenna is provided with a relatively narrow beam width of typically 5°-45°. This is usually referred to as a “petal” and provides a number of advantages. Firstly, it may be possible to reuse the frequency from the same station, increasing the bandwidth available. For example, it may be possible to re-use the same channel from the same broadcasting site as many as 5 or more times. Secondly, the amount of power required to transmit will be substantially reduced, saving energy and cost. Thirdly, the coverage can be altered to match the geographical disposition of the population.

In a further preferred embodiment of this aspect, the means for transmitting data is arranged such that at least one of beam width or transmission power of a transmitted signal is less than that for a broadcast transmitter in the same frequency band.

According to a second aspect of the present invention, there is provided a method of utilizing frequency spectrum using a plurality of geographically-separate broadcast sites, the method comprising:

for at least one geographical area served by a first broadcast site and for at least one channel which is utilized by at least a second broadcast site, which second broadcast site serves an adjacent geographical area to that served by the first site;

determining those portions of the first geographical area to which broadcasts on the at least one channel from the second broadcast site cause interference; and

transmitting data on the at least one channel in sections of the first geographical area which sections lie outside those portions determined to suffer from interference.

According to a third aspect of the present invention, there is provided a method of sending data from the internet to a remote computing device, the method comprising:

receiving data from an internet server and transmitting that data from at least one transmitter in a band used for broadcasting terrestrial signals.

According to a fourth aspect of the present invention, there is provided apparatus for receiving terrestrial digital television signals comprising:

means for connection to an antenna; and

means for down-converting and demodulating a signal received from the antenna;

which apparatus further comprises:

means for deriving a digital data signal from a demodulated received signal which digital data signal comprises non-television signal data; and

means for supplying the digital data signal to a computing device.

This aspect of the invention may be realized either by a television set or a set top box (STB).

According to a fifth aspect of the present invention, there is provided a data capture apparatus for use with an apparatus for receiving terrestrial digital television signals, the data capture apparatus comprising:

means for physical and electrical connection to the apparatus for receiving terrestrial digital television signals;

means for deriving digital data signal via an electrical connection to the apparatus for receiving terrestrial digital television signals; and

means for supplying the digital data signal to a computing device.

Existing set top boxes are provided with a common interface slot into which this data capture apparatus will fit. The user then connects this data capture apparatus to his personal computer, for example, to complete the high data rate path from the internet. The data capture apparatus may further be provided with a return path from the user, for example via a modem and the PSTN.

The present invention will now be described, by way of non-limiting example, with reference to the accompanying drawings, in which:

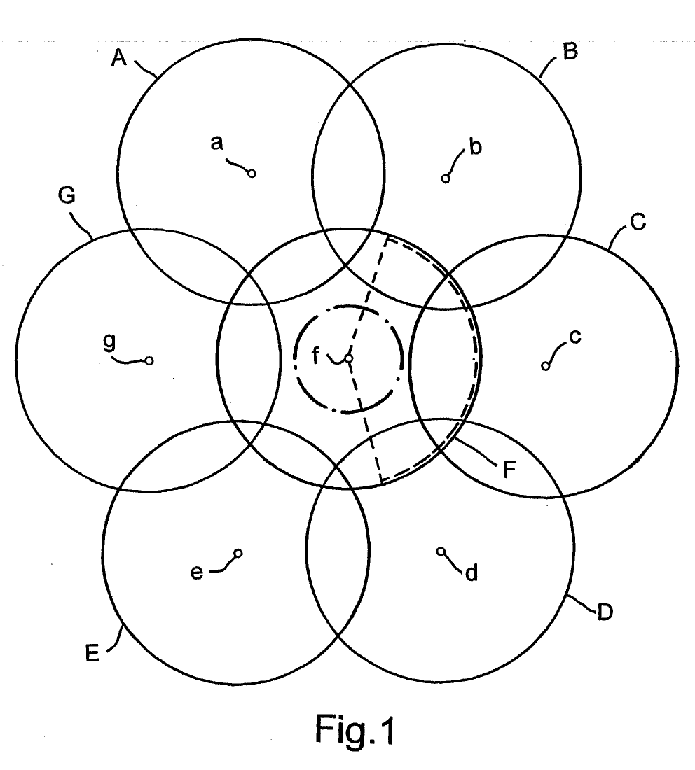

FIG. 1 illustrates the problem of overlap in coverage between adjacent transmission areas and the principle behind the invention;

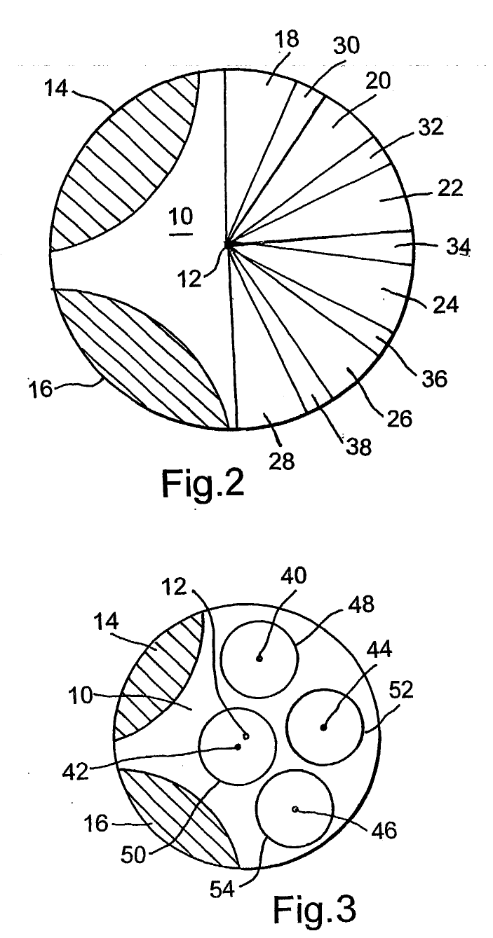

FIG. 2 shows an example of directional transmitters being used from a television transmission station;

FIG. 3 shows an example of omnidirectional transmitters being used within a broadcast transmission area;

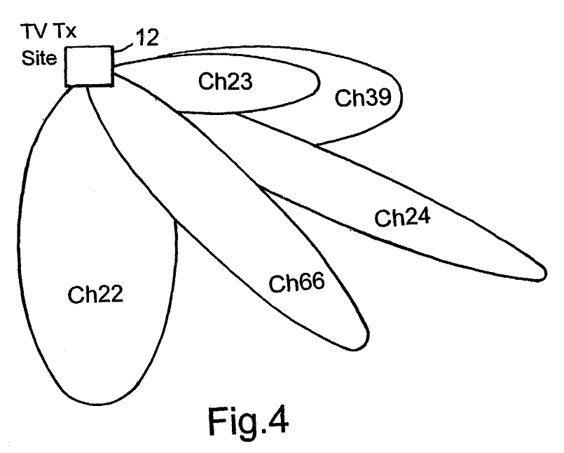

FIG. 4 shows an example of transmission areas using a number of different channels from a single broadcast site;

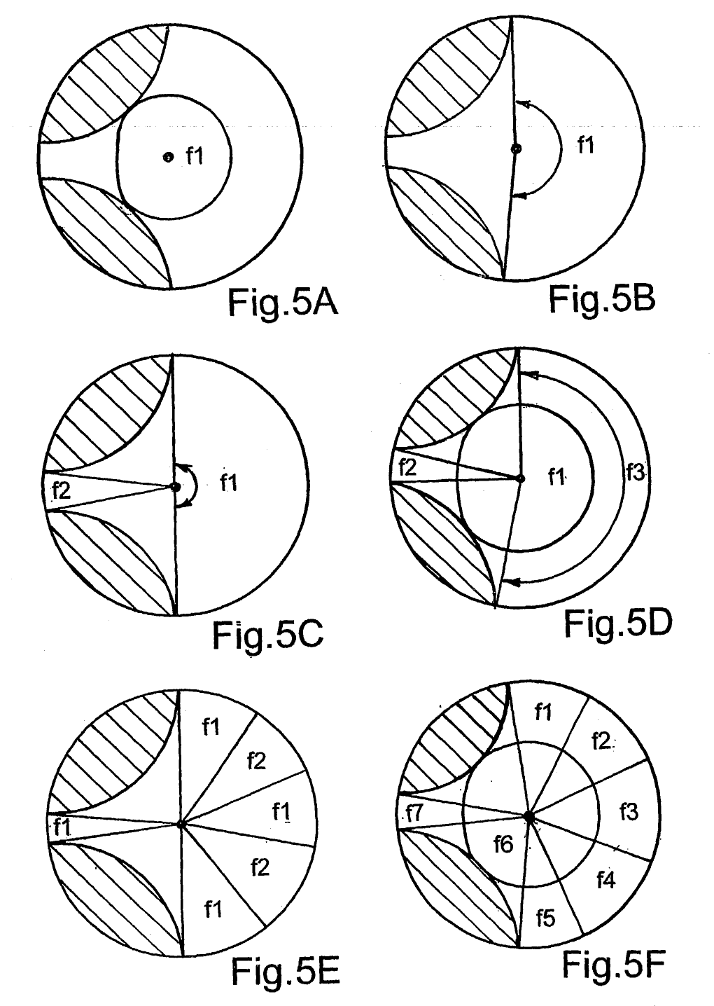

FIG. 5 shows some alternative direction transmission patterns;

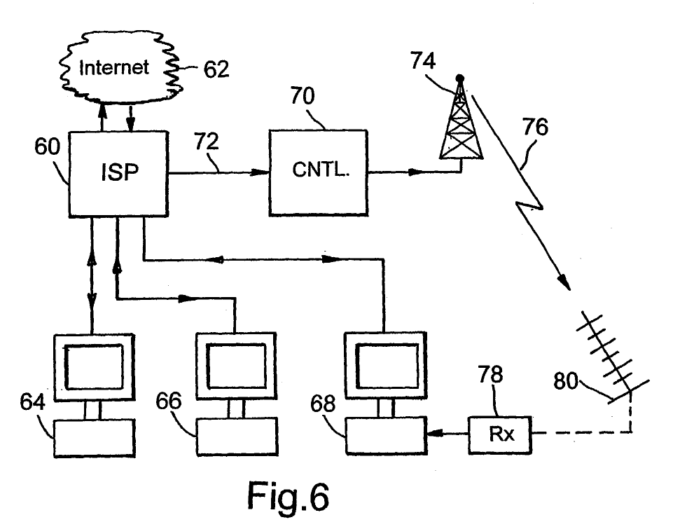

FIG. 6 shows a block schematic diagram of the invention being used by an Internet service provider (ISP) to provide a premium service of rapid web page download;

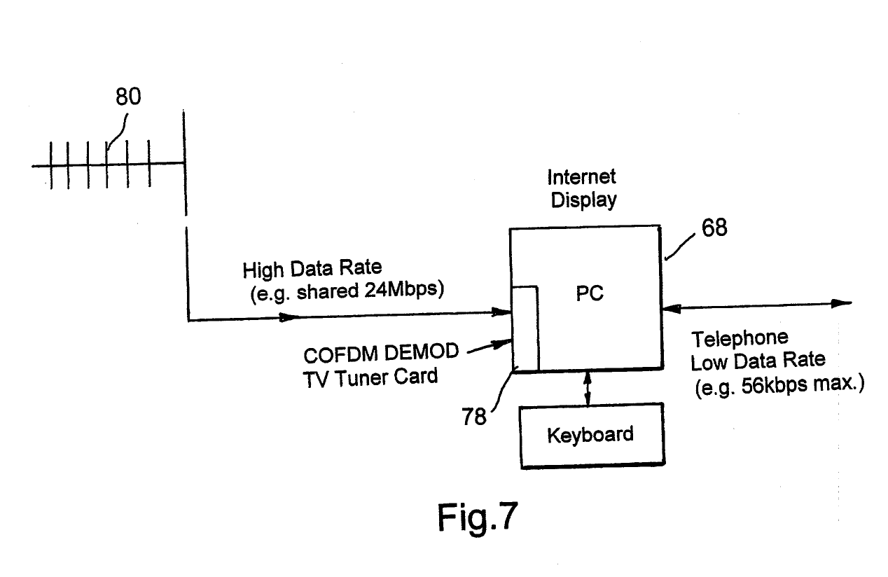

FIG. 7 is a block schematic diagram of an embodiment of the invention in which a tuner card is provided within a personal computer;

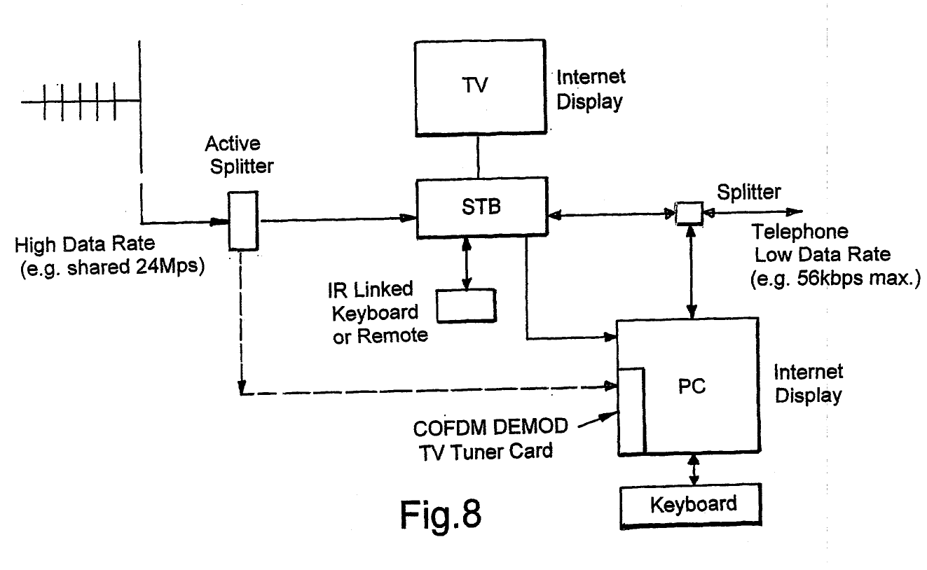

FIG. 8 shows an alternative embodiment in which the reception of the UHF television signals, down-conversion and demodulation is carried out by a set-top box (STB);

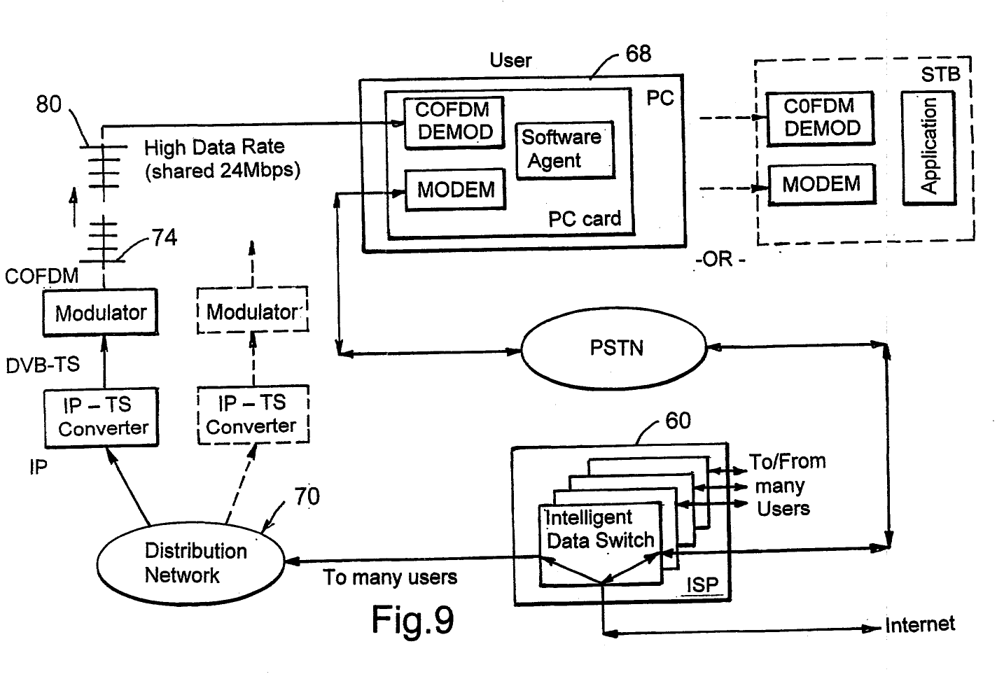

FIG. 9 shows a block schematic diagram similar to that shown in FIG. 6, giving a more detailed view of certain elements of the system; and

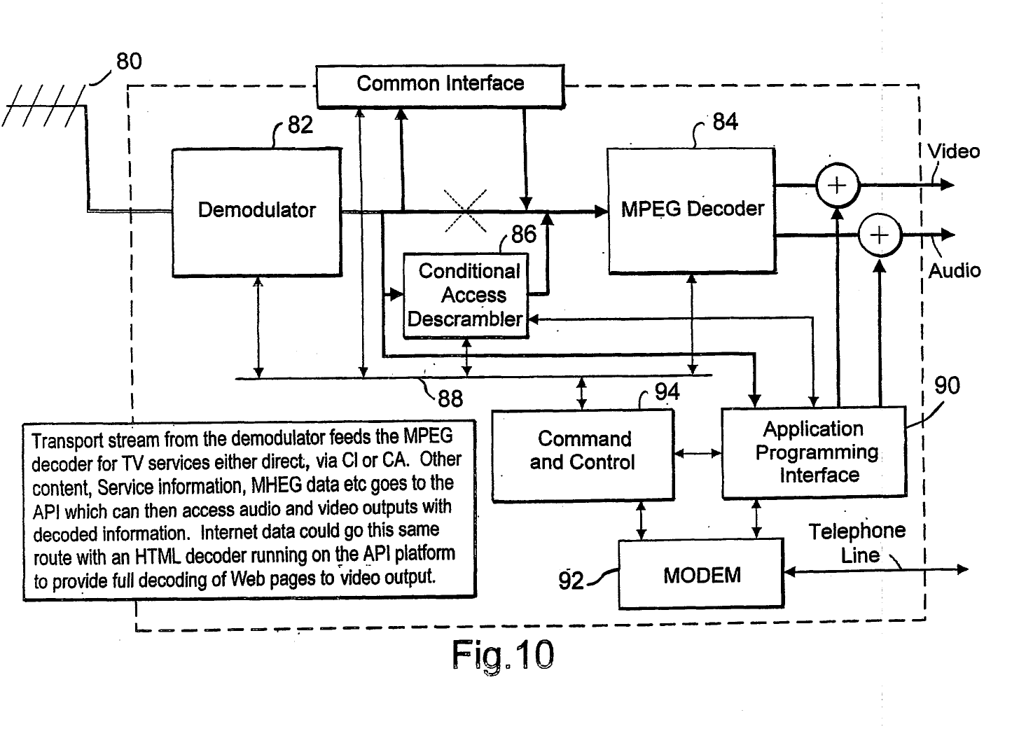

FIG. 10 shows a block schematic diagram of a modified set-top box (STB) shown in FIG. 8.

While the examples that follow are restricted to the use of television channels in the United Kingdom, the skilled person will readily appreciate that the invention may be applied to other terrestrial broadcast systems (e.g. radio broadcasts), in other frequency bands and in any country.

FIG. 1 is a plan view of an area usually called the service area covered by a number of television transmitters a,b,c . . . g. Each transmitter provides coverage of an associated area A, B, C . . . G. In the figure these are shown as circles but in practice, of course, they will be irregular shapes determined by the antenna characteristics and propagation behaviour of the area. It will be possible, for example, to use the same frequency band or channel to broadcast from both transmitter a and transmitter e because they are clearly geographically separate. However, it will not be possible to transmit from transmitter f using the same channel because of the areas of substantial overlap between area E and area F, and area A and area F.

The channel is said to be “sterilised” in the area F, in other words it cannot be used.

If the number of overlapping areas are considered (for example area F overlaps with six other areas) it will readily be appreciated that this causes a significant reduction in the usable bandwidth. For example, in the UK, there are 46 broadcast channels between channel 21 and channel 68 (Channel 36 is currently used for radar and channel 38 is used for astronomy). At any given broadcast station between four and thirteen of the channels are in use. This gives between thirty three and forty two unused channels at each station. Generally, these channels cannot be used for broadcasting because of the interference that would be caused to neighbouring stations. They can, however, be used to provide limited coverage over narrow arcs or omnidirectional cover at limited power. The first of these is illustrated in FIG. 1 by an area surrounded by a dotted line in area F and the second is illustrated by a smaller dot-dash circle within the area F.

FIG. 2 shows a service area 10 served by a centrally located transmission site 12. For the purpose of this description, the discussion will consider only one channel, that is a particular range of frequencies. Transmitters in two separate areas adjacent to the area 10 broadcast on that channel. The transmitters are not shown in the figure but their coverage extends into two hatched sections 14, 16 shown in FIG. 2. Clearly, it will not be possible to broadcast on this channel from the transmitting site 12 at the usual power level.

However, by using one or more directional antennas, the particular channel can be used over much of the remainder of the geographical area 10. While it would be possible to provide a directional antenna with a wide beam angle (approaching 180°) to provide a coverage area similar to that delimited by the dotted lines in area F of FIG. 1, it is preferred to use a number of smaller directional antennas to provide so-called “petals” of coverage. These are shown as areas 18, 20, 22, 24, 26 and 28. Six directional antennas will thus be required. These are arranged so as to provide the petals of coverage and safety zones 30, 32, 34, 36 and 38 between adjacent petals. These safety zones are provided to prevent the transmissions in one petal from interfering with those of an adjacent petal or petals.

FIG. 2 shows the transmission patterns which will be provided by a number of directional antennas co-located with existing broadcast antennas. Where the receive antennas used by users are directional then co-location or near co-location will be required. However, where the receiving antennas are not directional, this will no longer be a requirement. Consequently, the spectrum may be exploited by use of transmission antennas which are not co-located (or nearly so) with an existing broadcast antenna.

FIG. 3 shows a coverage area 10 similar to that shown in FIG. 2 with intrusions (on a particular channel) over areas 14, 16 caused by adjacent transmitters. Unlike the arrangement shown in FIG. 2, however, the usable (unhatched) part of the area 10 is served by a number of omnidirectional antennas transmitting at lower power than that of the broadcast station 12. Four such transmitting sites 40, 42, 44 and 46 serve areas 48, 50, 52 and 54 respectively. One transmitting site 42 may be co-located with the broadcast station 12 for convenience. The power levels used at transmitting sites 40, 42, 44 and 46 are chosen so that interference between adjacent sites does not occur. On the figure this is illustrated by spacing between areas 48, 50, 52 and 54.

The skilled person will appreciate that the use of directional antennas (whether or not from an existing broadcast site) may be combined with omnidirectional transmission from other sites.

FIG. 4 shows a terrestrial television transmission site 12 from which five different petals of additional data broadcasting are shown. Channel 22 is used by a relatively wide petal at high power, channel 66 is used by a narrower petal at relatively high power, channel 24 is used by a slightly narrower petal again at a similar power level while channels 39 and 23 are broadcast at lower power levels with a reasonably broad and a rather narrow petal respectively.

FIG. 5 shows six examples of transmission patterns using directional antennas, omnidirectional antennas or combinations of both. FIG. 5A shows the use of an omnidirectional antenna from the existing broadcast site, whose power output is selected so as not to suffer from interference caused by broadcast signals from adjacent service areas. FIG. 5B illustrates use of a directional antenna covering approximately 180° of arc co-sited with the existing broadcast antenna. The directional antenna is oriented to avoid interference with the broadcast signals from adjacent broadcast sites. FIG. 5C expands the situation shown in FIG. 5B by providing a further, but somewhat narrower, directional antenna to exploit the region of the service area between the interference caused by adjacent transmitters. FIG. 5D utilizes the techniques illustrated in FIG. 5A and FIG. 5C. The omnidirectional transmission (as shown in FIG. 5A) must transmit on a different channel from that of the directional transmissions. FIG. 5E shows a number of petals of transmission using two different channels, shown as f1 and f2. The areas covered by channel f2 are located between those covered by channel f1 so as to provide the necessary safety zones. FIG. 5f shows 6 areas served by directional antennae and 1 area served by an omnidirectional antenna from the existing broadcast site. Interference is avoided by using 7 different channels, designated f1, f2 . . . f7.

FIG. 6 shows an Internet service provider (ISP) 60 having a bidirectional connection to the Internet 62 as is well known. In addition, the ISP also has a number of subscribers, represented here by personal computers 64, 66 and 68. Connections between the ISP and the subscribers will generally be by way of dial-up modem operating at a low data rate, typically 33 kilobits per second.

In addition to the bidirectional connections to subscribers the ISP is also connected to a controller 70 by way of a very high capacity data link 72. The controller 70 is also connected to a transmitter 74, typically a directional transmitter located at a television broadcast site. The controller 70 will typically be located at the TV broadcast site and will include the necessary multiplex circuitry, modulation circuitry and so on to convert a high data rate signal from the ISP into a signal in the UHF television broadcast band. This signal is then transmitted as shown at 76.

One of the subscribers 68 to ISP 60 has an additional data receiver 78 connected to his existing television antenna 80. The receiver 78 may conveniently be provided as a card within the user's PC. The user's antenna 80 may then be used to receive existing analogue and/or digital television services as well as high speed data from ISP 60. Data receiver 78 will be discussed in more detail below but the necessary circuitry will be well within the competence of an engineer familiar with digital terrestrial television.

In operation, Internet subscriber 68 will be using the Internet, for example visiting a number of sites on the World Wide Web and downloading information therefrom. If the subscriber requests a file which is above a certain size, the ISP may send a message to subscriber 68 indicating the likely length of download time and offering a premium high data rate service via the controller 70 and data receiver 78. Alternatively, the ISP may automatically send the file via the high data rate path depending upon the agreement between the subscriber and the ISP.

FIG. 7 shows an embodiment of the receive end of user 68 shown in FIG. 6. The user's PC is provided with a keyboard and a bidirectional data transfer link via a telephone line as is known. A connection is provided to the user's existing television antenna 80 and this is connected to a coded orthogonal frequency division multiplex (COFDM) demodulator card mounted within the PC. This provides a very neat way of accessing the high data rate “pipe” which may be provided by the invention. All the user will have to do is run an additional coaxial cable from his television antenna to his personal computer.

In the specification it is assumed that the digital data is transmitted over the terrestrial TV channels using the DVB-T standard. In this standard an 8 MHz channel (capable of carrying 1 analogue television station) is used to provide 1705 carriers coded using a 64 quadrature amplitude modulation (QAM), a 2/3 code rate and a 1/32 guard interval. This provides an error protected channel at 24 Mbps

FIG. 8 shows an alternative arrangement in which the user's PC receives data via the high data rate “pipe” from a set-top box (STB). The advantage of this arrangement is that the down-conversion and demodulation hardware and software has already been provided in the STB for terrestrial digital television. The user simply needs to run a cable from the STB to a special PC card in the PC and the arrangement will operate in the same manner as that shown in FIG. 7.

FIG. 8 also shows an alternative arrangement in which the television (TV) may also be used as an Internet display, as well as a regular television. The set-top box is preferably provided with an infra-red remote link to a keyboard, which may be used when the Internet function of the TV is in use. The low-data-rate bidirectional link such as provided by a telephone line and modem is connected via a splitter to both the PC and STB. Of course, the PC may be omitted completely, allowing the user Internet access by way of his television.

FIG. 9 shows a similar block diagram to that shown in FIG. 6 including an alternative means of downloading the data using a set top box (STB). The diagram also shows a software agent that provides address verification and data filtering as well asderiving the signals from the correct interface.

FIG. 10 shows a block schematic diagram of an embodiment of a set top box in accordance with one of the aspects of the invention. A user's television antenna 80 is connected to a demodulator 82 and the demodulated output signal is fed to an MPEG decoder 84. The common interface allows further processing of the demodulated signal in an external card. The MPEG decoder 84 operates to provide video and audio output to a television as is known. In the case of pay-to-view programmes, the connection between demodulator 82 and MPEG decoder 84 is provided via conditional access descrambler 86. This operates using known technology, for example smart cards, to ensure that only those entitled to view programmes can do so.

An application programming interface (API) 90 is provided with the output of the demodulator 82 and is also connected to a modem 92. The modem 92 is connected to a telephone line as is known. The modem 92 and API 90 operate under control of a command unit 94. A bus 88 is provided within the STB to allow communication between individual units. Command and control 94 also controls the demod and MPEG decoding. An application running on the API 90 can thus be used to allow a user fast internet access using such control means (e.g. keyboard, mouse, track ball, etc.) as is known. When the set top box is being used as an internet device, the API 90 provides the relevant video and audio to the television.

Naturally, the elements shown in FIG. 10 may be incorporated into a digital television receiver rather than being located in a separate set top box.

1. A broadcasting system comprising a plurality of geographically separate transmitting stations, the system comprising:
a first transmitting station comprising means for broadcasting on a first channel over a first area of coverage;
a second transmitting station comprising means for broadcasting over a second area of coverage which overlaps with the first area of coverage;
further comprising means for transmitting data on the first channel over a portion of the second area of coverage that is distinct from the overlap between the first and second broadcast areas.

2. A broadcasting system as claimed in claim 1, wherein the means for transmitting data on the first channel are co-sited with the second transmitting station.

3. A broadcasting system as claimed in claim 1 or claim 2, wherein the means for transmitting data comprises means for transmitting data derived from the internet.

4. A broadcasting system as claimed in any one of claims 1 to 3, wherein the means for transmitting data is arranged such that at least one of the beam widths or transmission power of a transmitted signal is less than that for a broadcast transmitter in the same frequency bands.

5. Method of utilizing frequency spectrum using a plurality of geographically-separate broadcast sites, the method comprising:
for at least one geographical area served by a first broadcast site and for at least one channel which is utilized by at least a second broadcast site, which second broadcast site serves an adjacent geographical area to that served by the first site;
determining those portions of the first geographical area to which broadcasts on the at least one channel from the second broadcast site cause interference; and
transmitting data on the at least one channel in sections of the first geographical area which sections lie outside those portions determined to suffer from interference.

6. A method as claimed in claim 5, wherein the step of transmitting data is carried out from the first broadcast site.

7. A method as claimed in claim 5 or claim 6, wherein the at least one channel comprises a terrestrial television broadcast channel.

8. A method as claimed in any one of claims 5 to 7, wherein the step of transmitting data comprises transmitting data with a beam width or transmission power of a transmitted signal which is less than that for a broadcast transmitter in the same frequency band.

9. A method of sending data from the internet to a remote computing device, the method comprising:
receiving data from an internet server and transmitting that data from at least one transmitter in a band used for broadcasting terrestrial signals.

10. A method as claimed in claim 9, wherein the band used for broadcasting terrestrial signals is a terrestrial television broadcast band.

11. A method as claimed in claim 9 or claim 10, wherein the step of transmitting the data is carried out from a site used for broadcasting terrestrial signals.

12. A method as claimed in any one of claims 9 to 11, wherein the step of transmitting the data comprises transmitting the data in the multiplex of a digital broadcast signal.

13. Apparatus for receiving terrestrial digital television signals comprising:
means for connection to an antenna; and
means for down-converting and demodulating a signal received from the antenna;
which apparatus further comprises:
means for deriving a digital data signal from a demodulated received signal which digital data signal comprises non-television signal data; and
means for supplying the digital data signal to a computing device.

14. Apparatus as claimed in claim 13, further comprising a visual display and audio transducer for showing a user terrestrial digital television programmes.

15. Data capture apparatus for use with an apparatus for receiving terrestrial digital television signals, the data capture apparatus comprising:
means for physical and electrical connection to the apparatus for receiving terrestrial digital television signals;
means for deriving digital data signal via an electrical connection to the apparatus for receiving terrestrial digital television signals; and
means for supplying the digital data signal to a computing device.

16. Data capture apparatus as claimed in claim 15, comprising a plug-in module connectable to an expansion port on the apparatus for receiving terrestrial digital television signals.
